(19) United States
(12) Patent Application Publication
(10) Pub. No.: US 2013/0320740 A1
(43) Pub. Date: Dec. 5, 2013

(54) System and Method for Converting a Chair into a Yoga Chair

(71) Applicant: Kristen Samiee, Austin, TX (US)

(72) Inventor: Kristen Samiee, Austin, TX (US)

(21) Appl. No.: 13/489,315

(22) Filed: Jun. 5, 2012

(51) Int. Cl. A47C 3/00; B23P 17/04; A47C 7/00

(52) U.S. Cl. 297/440.1; 29/401.1

(57) ABSTRACT

A system and method for converting a yoga chair into a chair is herein disclosed. Specifically the yoga chair comprising a seat, wherein said seat comprises a flat surface capable of supporting a user's body in a yoga position, a base, and a quick release system that connects said seat to said base. In one embodiment, the quick release system can comprise a snap mechanism. In another embodiment, the quick release system can further comprise a plate comprising a plate orifice, wherein the base comprises a shaft. In another embodiment, quick release system can comprise a shaft cap that mates with a shaft on base.

### BACKGROUND

This disclosure relates to a system and method for converting the upper seat of an office chair seat with a removable yoga seat.

Today, many people practice the art of yoga as a way of life to promote good health, and proper discipline. Some yoga followers are individuals who spend several hours a day in front of a computer doing work, surfing the net, studying and/or doing other desk jobs, thereby spending long hours sitting on an office chair at a desk. Instead of sitting at a standard sitting position, many yoga practitioners prefer sitting at a cross-legged or lotus position. The strain of working at an uncomfortable position can also result to lack of concentration and reduce performance. However, sitting at a lotus position on an office chair can be difficult as well as uncomfortable, due to the limited seating space.

Instead, some individuals may opt to use a yoga chair. However, this wouldn't be a great option for working individuals who interacts or meets with a client, as using a yoga chair during meetings would look very unprofessional and disrespectful. Another option would be to buy or own both an office chair and a yoga chair, but not only will it be expensive but also it would be inconvenient and can consume and require larger area. Additionally, switching and moving from one chair to another can be inconvenient and time-consuming.

As such it would be useful to have an improved system and method for a removable yoga seat.

### SUMMARY

A system and method for converting a yoga chair into a chair is herein disclosed. Specifically the yoga chair comprising a seat, wherein said seat comprises a flat surface capable of supporting a user's body in a yoga position, a base, and a quick release system that connects said seat to said base. In one embodiment, the quick release system comprises a snap mechanism, said snap mechanism comprising a socket; and a protruding member comprising a catch, said protruding member linkable to said socket. In another embodiment, the quick release system can further comprise a plate comprising a plate orifice, further wherein said base comprises a shaft, wherein said shaft mates with said plate orifice. The base can comprise a shaft, further wherein said quick release system further comprises a shaft cap, wherein said shaft cap fits over a portion of said shaft. The base can further comprise a plurality of castor wheels. The yoga chair comprises one or more sides each connected to said seat, said sides each angling less than twenty degrees from said seat. In one embodiment, the seat can be circular or predominantly rectangular.

A method for converting a chair into a yoga chair is further disclosed. Specifically, the method comprises attaching a yoga seat to a base with a quick release mechanism, removing said yoga seat from said base by releasing said quick release mechanism, and attaching a second seat to said base using a second quick release mechanism.

### BRIEF DESCRIPTION OF THE DRAWINGS

FIG. 1 illustrates a yoga chair that can comprise a yoga seat, and a base.

FIG. 2A illustrates how a yoga seat can be attached to a base through snap mechanism.

FIG. 2B illustrates a closer view of a snap mechanism.

FIG. 3A illustrates how a yoga seat can be attached to a base through a concave insert.

FIG. 3B illustrates a closer view of a concave insert.

FIG. 4A illustrates how a yoga seat can be attached to a base through a shaft cap.

FIG. 4B illustrates a closer view of a shaft cap.

FIG. 5A illustrates a yoga seat which can further comprise a seat, and one or more sides.

FIG. 5B illustrates an embodiment of a seat having a flat and round top.

FIG. 6 illustrates an embodiment of an office chair attached to a base.

### DETAILED DESCRIPTION

Described herein is a system and method for a removable yoga seat. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system-and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

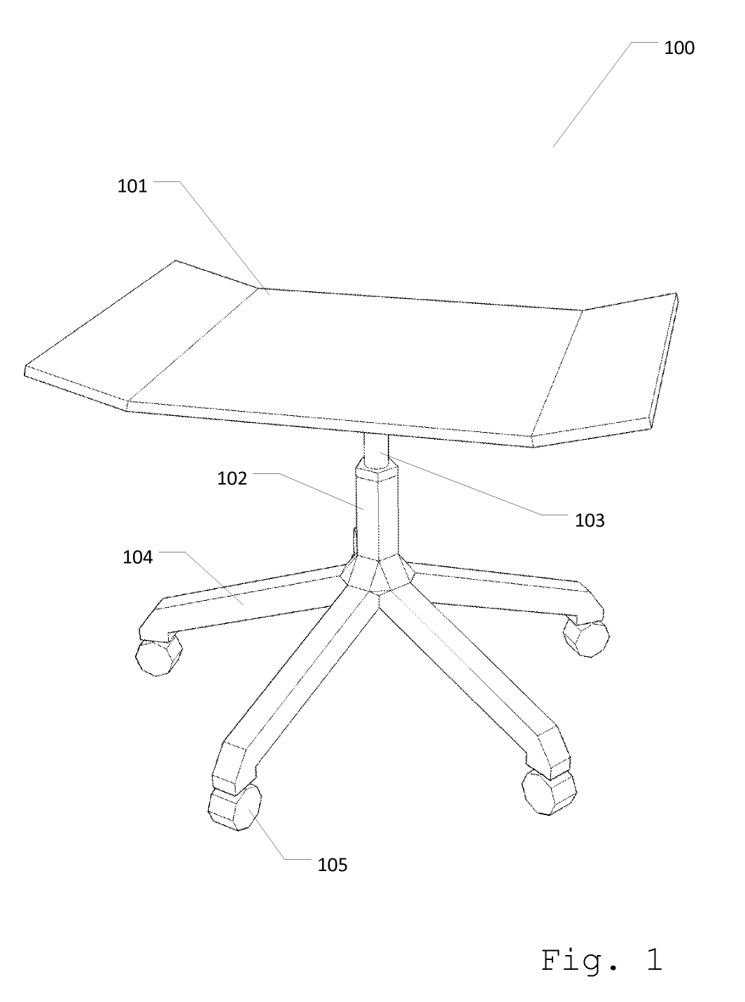

FIG. 1 illustrates a yoga chair 100 which can comprise a yoga seat 101, and a base 102. For purposes of this disclosure, yoga chair 100 can be made of any desired materials which include but are not limited to wood, plastics, cushions, and/or metals. As such, yoga chair 100 can be designed in any form, shape, and/or size. Further, base 102 can be the lower portion of an office chair. In one embodiment, base 102 can be any standard office chair base. In another embodiment, base 102 can be a customized office chair base designed to be mateable with yoga seat 101. Further, base 102 can comprise a cylindrical shaft 103, one or more base legs 104, and/or a plurality of wheel 105 which can be designed to support, and balance the weight of a user and yoga seat 101. For purposes of this device cylindrical shaft 103 can be a rod that joins yoga seat 101 and base 102 of yoga chair 100. As such, cylindrical shaft 103 can be a gas lift or spring which is covered with a metallic telescoping cover to form a column. In one embodiment, top edge of cylindrical shaft 103 can be designed to have ridges resembling a screw. In another embodiment, top edge of cylindrical shaft 102 can be flat and does not comprise of ridges. Base legs 104 can be the extended lower portion of base 102 which can be used to balance and support yoga seat 101. In one embodiment, base legs 104 can be flat and directly touch the floor. In another embodiment, base legs 104 can comprise plurality of castor wheels 105. As such, yoga chair 100 can be easily moved or glide from one place to another.

Further for purposes of this disclosure, yoga seat 101 can be detached from base 102. As such, an upper seat of a standard office chair can be placed onto base 102 to replace yoga seat 101, and vice versa. In an embodiment wherein base 102 can be customized to fit yoga seat 101, upper seat of a standard office chair can also be mateable with base 102.

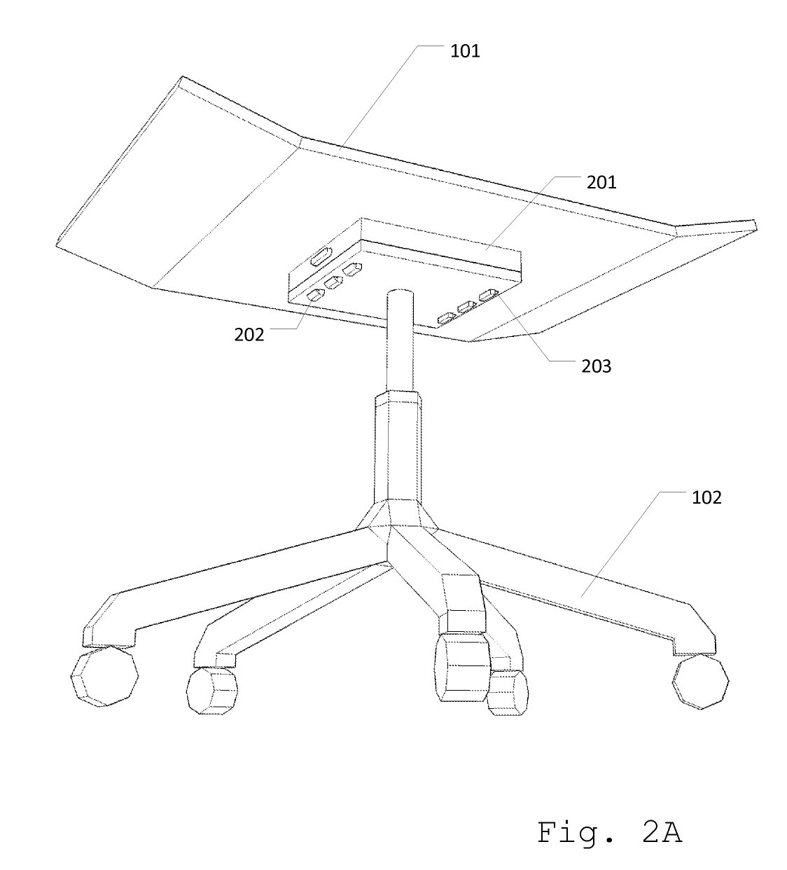

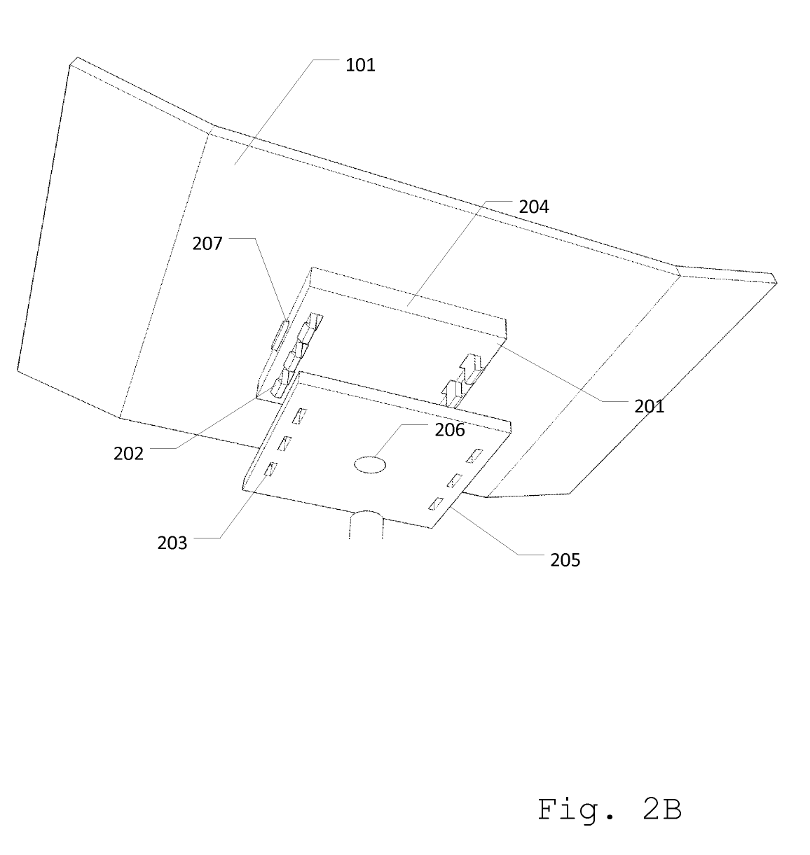

FIG. 2A illustrates how yoga seat 101 can be attached to base 102 through a snap mechanism 201. Snap mechanism 201 can be any fastening device that can comprise a pair of interlocking parts, including a socket and a protruding member comprising a catch, where protruding member is linkable to the socket. Further, snap mechanism 201 can comprise a male snap 202 and a female snap 203. Male snap 202 can be the part of snap mechanism 201 that comprises a protruding part or a snapper. While, female snap 203 can comprise an orifice that can securely hold male snap 202. In such embodiment, male snap 202 can be attached to yoga seat 101 while, female snap 203 can be attached to cylindrical shaft 103. As such, yoga seat 101 can be pushed against base 102 therefore attaching male snap 202 and female snap 203 together.

FIG. 2B illustrates a closer view of a snap mechanism 201. Snap mechanism 201 can comprise a casing 204, and a plate 205. Casing 204 can be an enclosed housing comprising a one or more male snap 202. Further, one side of casing 202 can be permanently attached to yoga seat 101 through a weld, adhesives, fastener devices, and/or any bonding materials. Plate 205 can be a durable flat surface which can comprise one or more female snap 203 and shaft guide 206. Shaft guide 206 can be an orifice wherein cylindrical shaft 103 can be permanently attached. Female snaps 203 can be placed at the opposite edge of plate 205. As such, casing 204 can be matable with plate 205. Furthermore, male snap 202 can comprise a snap insert 207 and a button 208. As such, when male snap 202 is pushed towards female snap 203, button 208 can retract and fit into the orifice of female snap 203. Pushing male snap 202 further can push button 207 out of the female snap 203. In such scenario, snap insert 207 can be held inside and/or in between orifice of female snap 203. Further, male snap 202 returns to its original protruding form therefore locking plate 205 into casing 204.

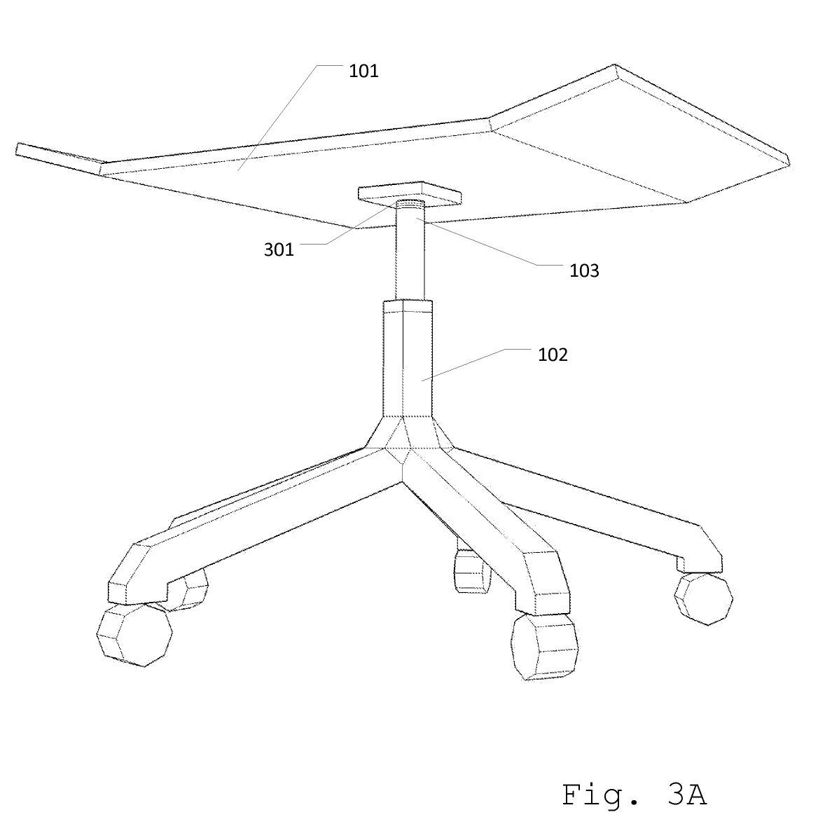

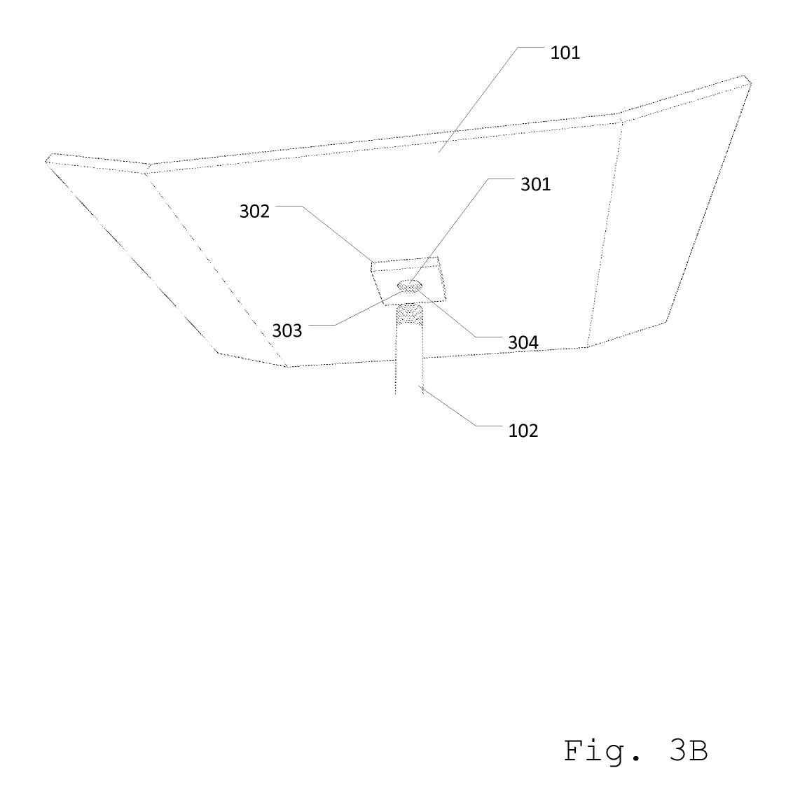

FIG. 3A illustrates how yoga seat 101 can be attached to base 102 through a concave insert 301. In an embodiment wherein the top edge of cylindrical shaft 103 comprises ridges, cylindrical shaft 103 can be inserted and screwed into concave insert 301. As such, yoga seat 101 can be rotated and/or twisted into cylindrical shaft 103 until yoga seat 101 is securely attached to base 102. Furthermore, when detaching yoga seat 101 from base 102, yoga seat 101 can be rotated in the opposite direction to loosen attachment from base 102.

FIG. 3B illustrates a closer view of concave insert 301. Concave insert 301 can comprise an insert plate 302. Insert plate 302 can be made of any durable material such as metal, wood, and/or hard plastic material. Further, one side of insert plate 302 can be permanently attached to yoga seat 101 through a weld, adhesives, fastener devices, and/or any bonding materials. Concave insert 301 can be a cylindrical column comprising an insert orifice 303. As such, insert orifice 303 can comprise of ridges 304 forming in the inner surface of insert orifice 303. Ridges 304 can be a narrow spiral elevation which can be used to lock and hold one end of cylindrical shaft 103 securely. Moreover, insert orifice 303 can be matable with cylindrical shaft 103.

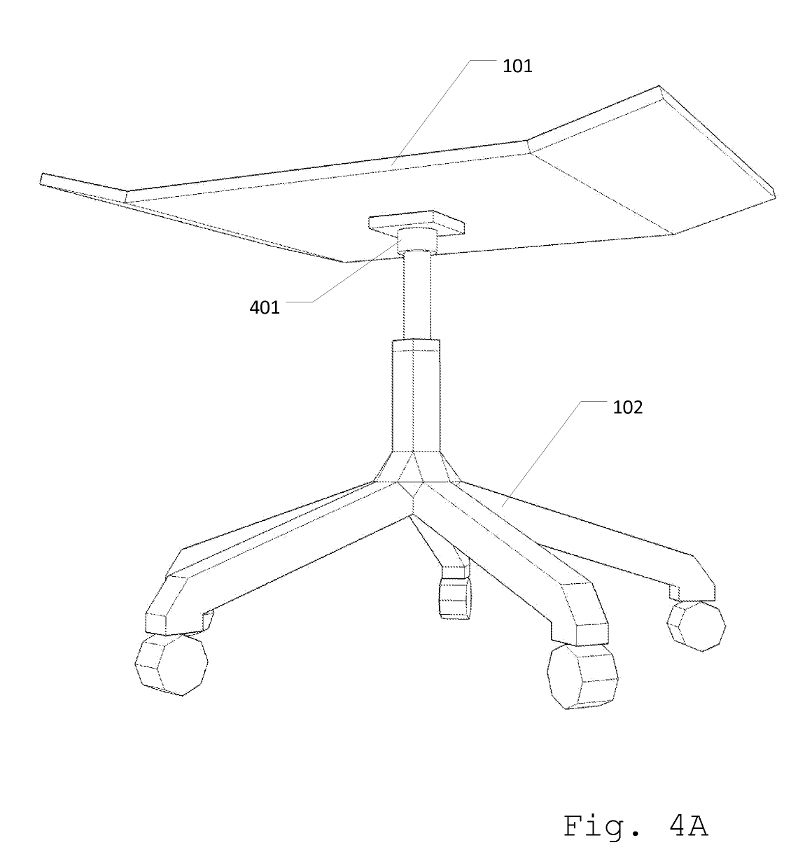

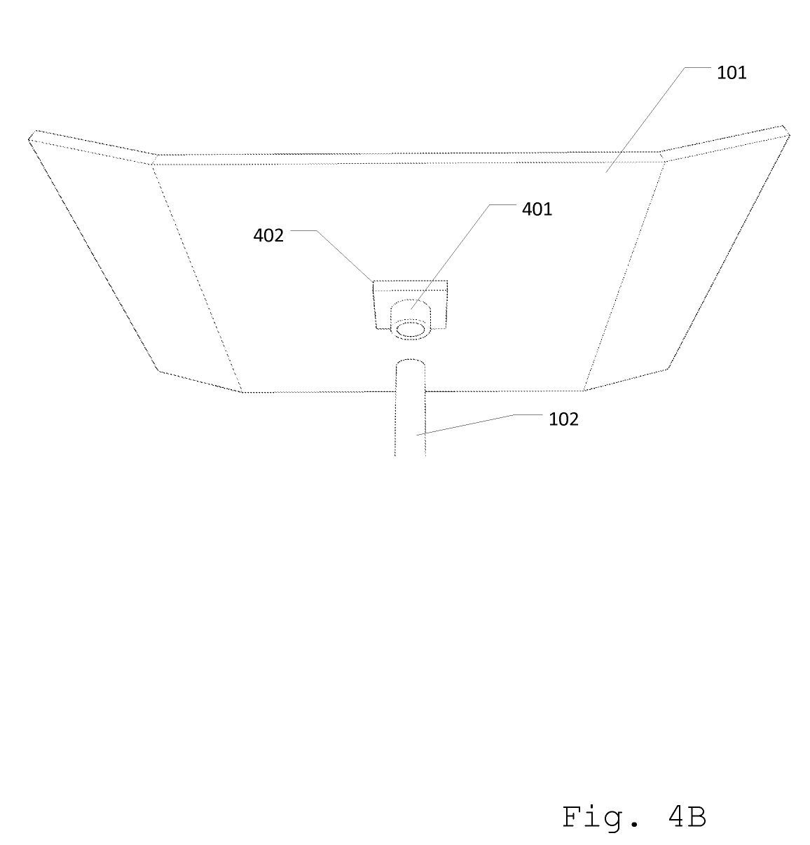

FIG. 4A illustrates how yoga seat 101 can be attached to base 102 through shaft cap 401. In such embodiment, yoga seat 101 can be attached to base 102 through insertion method. As such, yoga seat 101 can be attached to base 102 by inserting cylindrical shaft 103 and pushing it into shaft cap 401. Further, yoga seat 101 can be detached from base 102 by pulling yoga seat 101 away from base 102.

For purposes of this device, shaft cap 401 can use any type of locking mechanisms to ensure that joined parts of yoga seat 101, and base 102 are securely fastened. Locking methods mentioned can include but are not limited to flip-lock mechanism, wing-lock mechanism, or twist-lock mechanism. Further, locking mechanism mentioned herein can be easily unlocked, and can be done with a simple flip, or twist.

FIG. 4B illustrates a closer view of shaft cap 401. Shaft cap 401 can comprise a ring plate 402. Ring plate 402 can be made of any durable material such as metal, wood, and/or hard plastic material. Further, ring plate 402 can be used to connect yoga seat 101, and base 102. As such, one side of ring plate 402 can be permanently attached at the bottom side of yoga seat 101 through a weld, adhesives, fastener devices, and/or any bonding materials. Further, the other side of plate 402 is where shaft cap 401 can be attached. Shaft cap 401 can be a cylindrical column comprising an orifice which can be matable with cylindrical shaft 103. As such, shaft cap 401 can be used to securely hold yoga seat 101 to base 102.

For purposes of this disclosure, shaft cap 401 can be designed to be deep, and tight enough to ensure that cylindrical shaft 103 can be inserted securely unto yoga seat 101. Further, in one embodiment the inner portion of shaft cap 401 can be designed to consist of rubber, wax, and or any elastic material. As such, shaft cap 401 can tightly hold cylindrical shaft 103 in place. Additionally, elastic materials inside shaft cap 401 ensures that yoga seat 101 does not get easily dislodged from base 102 when a user stands up, move, or changes seat position.

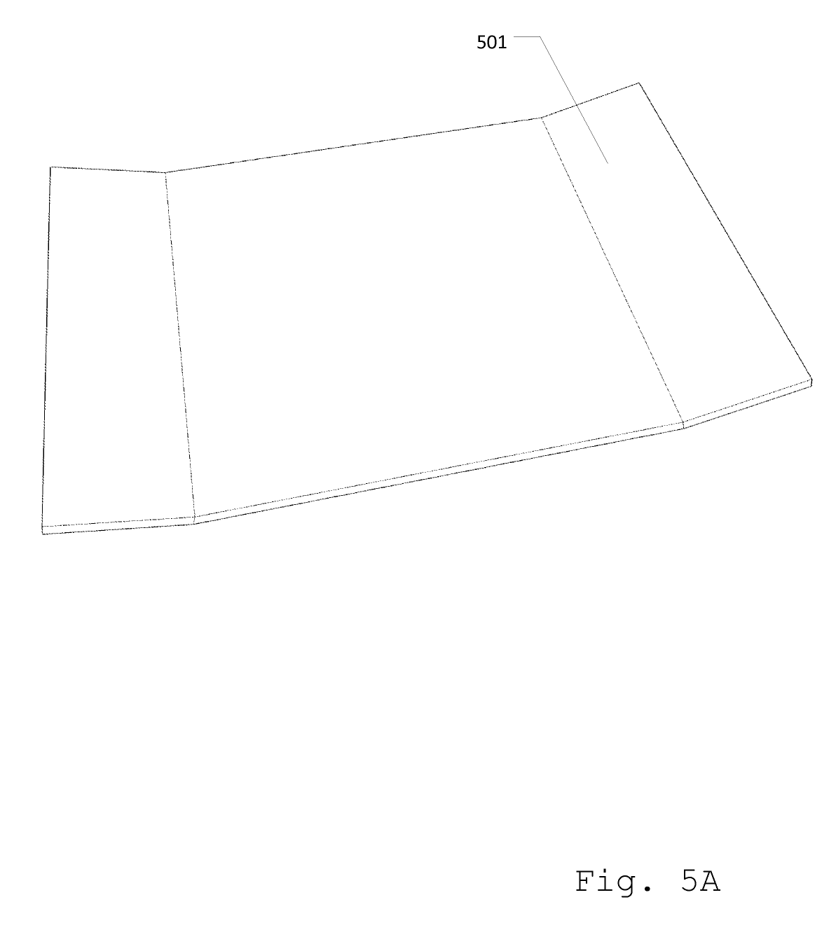

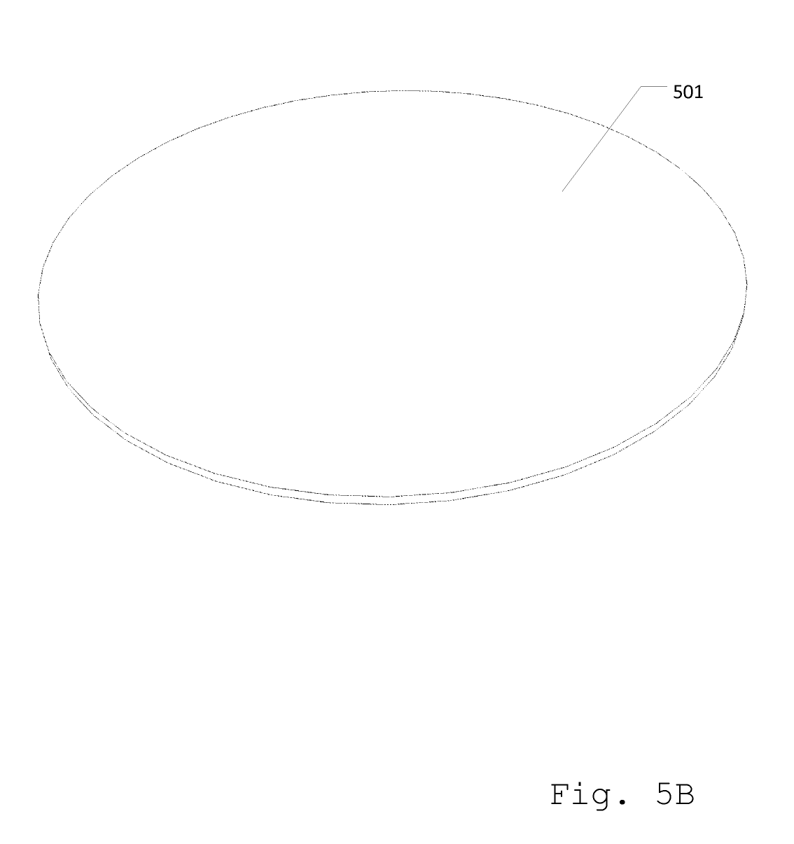

FIG. 5A illustrates yoga seat 101 comprising one or more sides 501. For purposes of this disclosure, yoga chair 101 can be a surface that provides primary support a user's body. Sides 501 can support the legs when a person is sitting in a half lotus position. In such embodiment, yoga chair 101 can be a flat seat surface wherein sides 501 can be laterally raised. As such, the upper body weight of a person sitting in a lotus position can be supported by yoga chair 101 while the legs can be laterally raised and held at certain angle. In one embodiment, sides can angle up at twenty degrees or less from the horizon. In another embodiment, sides can angle up at thirty degrees or less from the horizon.

FIG. 5B illustrates an embodiment yoga chair 101 having a flat top with no sides 501. In such embodiment, yoga chair 101 can be circular, oval or rectangular in shape, and designed to support the upper body weight of a person. Flat round top of yoga chair 101 in this embodiment can allow a person to sit in a full lotus position, wherein the knees can be pointed towards the ground. Yoga chair 101 can be cushioned, rubberized or padded to provide comfort for the user. In one embodiment, sides 501 can be permanently attached to yoga chair 101 through a weld, adhesives, and/or any bonding materials. In another embodiment, sides 501 can be attached to yoga chair 101 through any fastener devices which include but are not limited to nails, screws, and/or hinges. In another embodiment, yoga chair 101 and sides 501 can be one unibody.

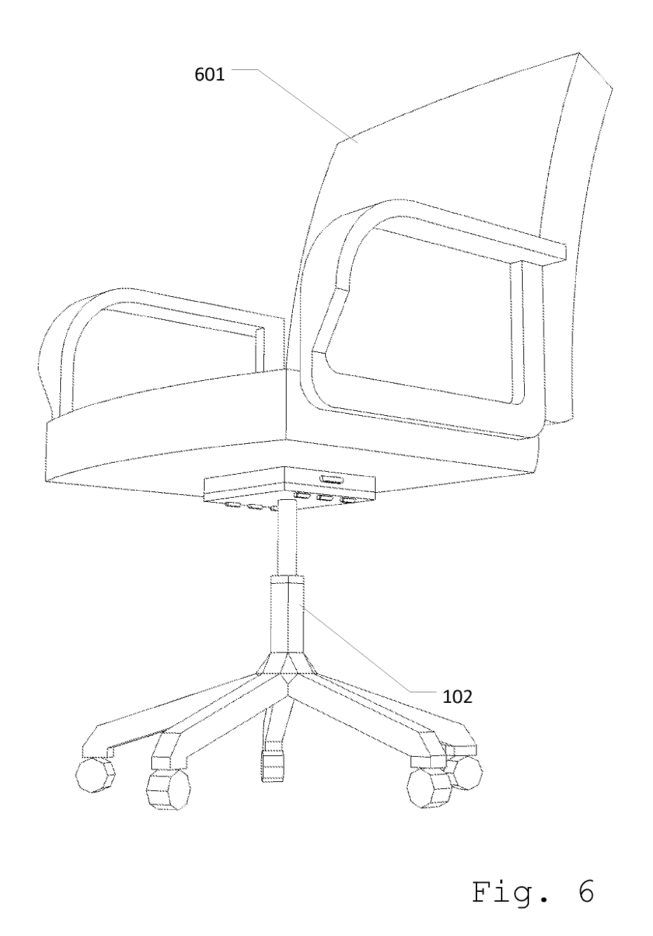

FIG. 6 illustrates an upper seat 601 of an office chair attached into base 102. In one embodiment, when yoga seat 101 is detached from base 102, upper seat 601 can be attached into base 102. As such, upper seat 601 can be used and function as a standard office chair. Such flexibility allows a user to have a chair for enjoying yoga positioning but also a more traditional chair as moments deem appropriate.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A yoga chair comprising
a seat, said seat comprising a flat surface capable of supporting a user's body in a yoga position;
a base; and
a quick release system that connects said seat to said base.

2. The system in claim 1, wherein said quick release system comprises a snap mechanism, said snap mechanism comprising
a socket; and
a protruding member comprising a catch, said protruding member linkable to said socket.

3. The system in claim 2, wherein said snap mechanism further comprises
a casing that houses said protruding members, and
a plate that comprises said socket.

4. The system in claim 3, wherein said casing further comprises a catch release that releases catch from said socket.

5. The system of claim 4 wherein said casing attaches to said seat, and said plate connects to said base.

6. The system of claim 4 wherein said casing attaches to said base and said plate connects to said seat.

7. The system in claim 1, wherein said quick release system further comprises plate comprising a plate orifice, further wherein said base comprise a shaft, wherein said shaft mates with said plate orifice.

8. The system in claim 7, wherein said plate orifice comprises a threaded orifice, wherein said shaft rotates into said threaded orifice.

9. The system in claim 1, wherein said base comprises a shaft, further wherein said quick release system further comprises a shaft cap, wherein said shaft cap fits over a portion of said shaft.

10. The system in claim 9, wherein said shaft cap comprises a ring plate that connects said shaft cap to said seat.

11. The system in claim 1, wherein said base comprises a plurality of castor wheels.

12. The system in claim 1, wherein said yoga chair comprises one or more sides each connected to said seat, said sides each angling less than twenty degrees from said seat.

13. The system of claim 1 wherein said seat is circular.

14. The system of claim 1 wherein said seat is predominantly rectangular.

15. A method for converting a chair into a yoga chair comprising
attaching a yoga seat to a base with a quick release mechanism;
removing said yoga seat from said base by releasing said quick release mechanism; and
attaching a second seat to said base using a second quick release mechanism.

16. The method in claim 14, wherein said quick release system comprises a quick release portion, further said second quick release mechanism comprising said quick release portion, said quick release portion attached to said base.

17. The method of claim 15, wherein removing said yoga seat from said base comprises pushing a catch release button.

18. The method of claim 15 wherein said quick release system further comprises plate comprising a plate orifice, further wherein said base comprise a shaft, wherein said shaft is mateable with said plate orifice, further wherein removing said yoga seat comprises rotating said seat until it disengages said base.

19. The method in claim 16, wherein said quick release mechanism comprises a shaft cap, further wherein removing said yoga seat comprises lifting said yoga seat off base.

20. The method of claim 19 further wherein attaching a second seat comprises setting second seat on base, wherein said second seat comprises a second shaft cap connectable to said base.
